(19) United States
(12) Patent Application Publication
(10) Pub. No.: US 2011/0036129 A1
(43) Pub. Date: Feb. 17, 2011

(54) RECEIVER LOCK ASSEMBLY

(76) Inventor: Donald R. FRANTZ, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/539,725

(22) Filed: Aug. 12, 2009

(51) Int. Cl. E05B 65/00; E05B 35/00

(52) U.S. Cl. 70/57; 70/344

(57) ABSTRACT

A receiver lock assembly has a shaft assembly and a lock head assembly. The lock head assembly comprises a fixed cam, steel balls and a movable cam. The movable cam includes a first end that can be rotated by a lock. In one lock position, the movable cam, which has each of the balls received within an aperture, is movable within the fixed cam in a first position and the cam is rotated such that the balls can be received by apertures within the fixed cam. In a second position, the fixed cam includes sloped apertures where, when the cam and balls are rotated, the balls engage a circumferential groove within the end of the shaft assembly. The rotating cam and the fixed cam allow the balls to move into and out of engagement with the grooved shaft on the shaft assembly to lock and unlock the head and shaft.

### FIELD OF THE INVENTION

The present invention relates generally to locks and to other security devices that use locks and locking mechanisms. More specifically, it relates to a receiver lock assembly that is used to secure a ball mount to a receiver that is attached to the rear of a towing vehicle.

### BACKGROUND OF THE INVENTION

In the experience of this inventor, it is not at all uncommon for a ball mount to be intentionally detached from a receiver and stolen. In the art of locks and other security devices, a subject that this inventor is intimately familiar with, receiver lock mechanisms have been devised for the purpose of deterring such theft. In the prior art, however, such locks can be relatively complicated in construction and often require the use of a separate locking mechanism that is not integrally formed as part of the receiver lock mechanism.

### SUMMARY OF THE INVENTION

In the view of this inventor, what is needed is a receiver lock assembly that is comprised of two primary components, one of which integrally forms the locking mechanism as part of the assembly. The first component is a shaft assembly. The second component is a lock head assembly. Preferably, the shaft assembly would include a straight shaft portion, having a smaller insertion end, the insertion end having a circumferentially defined groove in it. This groove would be intended to receive a portion of one or more steel balls that engage the groove when the lock head assembly is actuated.

The present invention provides such an assembly. When used as intended, the assembly of the present invention helps to prevent inadvertent detachment or intentional theft of the ball mount from the receiver. The present invention provides for a unique locking assembly having a number of components that form such a device.

The assembly of the present invention includes a lock head assembly that comprises a lock head that is essentially a barrel-like structure. To one side or end of the barrel-like structure, is inserted a fixed cam, three steel balls and a movable cam. The movable cam includes a first end that can be rotated by one end of a lock. In one position of the lock, the cam, which has each of the balls received within an aperture in the cam, is movable within the fixed cam in a first position and the cam is rotated such that the balls can be received within small apertures defined within the fixed cam. In a second position, the fixed cam includes sloped receiving apertures with, when the cam and the balls contained within it are rotated, the balls are forced into engagement with a groove that is circumferentially-defined within the end of the shaft assembly. Thus, the rotating cam and the fixed cam allow the balls to move into and out of engagement with the grooved shaft on the shaft assembly to lock and unlock the head and shaft, respectively.

The foregoing and other features of the receiver lock assembly of the present invention will be apparent from the detailed description that follows.

### BRIEF DESCRIPTION OF THE DRAWINGS

FIG. 1 is a front, top and left side perspective view of a hitch receiver that uses a receiver lock assembly constructed in accordance with the present invention.

FIG. 2 is a left side elevational view of the receiver lock assembly of the present invention and showing the assembly in the “locked” position.

FIG. 3 is an enlarged and exploded left side elevational view of the lock assembly illustrated in FIGS. 1 and 2.

FIG. 4 is a further enlarged and partially sectioned left side elevational view of the lock assembly and showing the assembly in the “locked” position.

FIG. 5 is an even further enlarged and partially sectioned front elevational view of that portion of the lock assembly shown in FIG. 4 taken along line 5-5 thereof, and showing the balls in the “unlocked” position.

FIG. 6 is the same view illustrated in FIG. 5, but showing the balls in the “locked” position.

FIG. 7 is a left side elevation view of an alternative embodiment of the receiver lock assembly illustrated in FIG. 1 and showing the assembly in the “locked” position.

FIG. 7A is an enlarged and partially sectioned left side elevational view of that portion of the lock assembly shown in FIG. 7 and taken along line 7A-7A thereof.

FIG. 8 is an enlarged and exploded left side elevational view of the lock assembly illustrated in FIG. 7.

FIG. 9 is a left side elevation view of another alternative embodiment of the receiver lock assembly illustrated in FIG. 1 and showing the assembly in the “locked” position.

FIG. 10 is an enlarged and exploded left side elevational view of the lock assembly illustrated in FIG. 9.

### DETAILED DESCRIPTION OF THE INVENTION

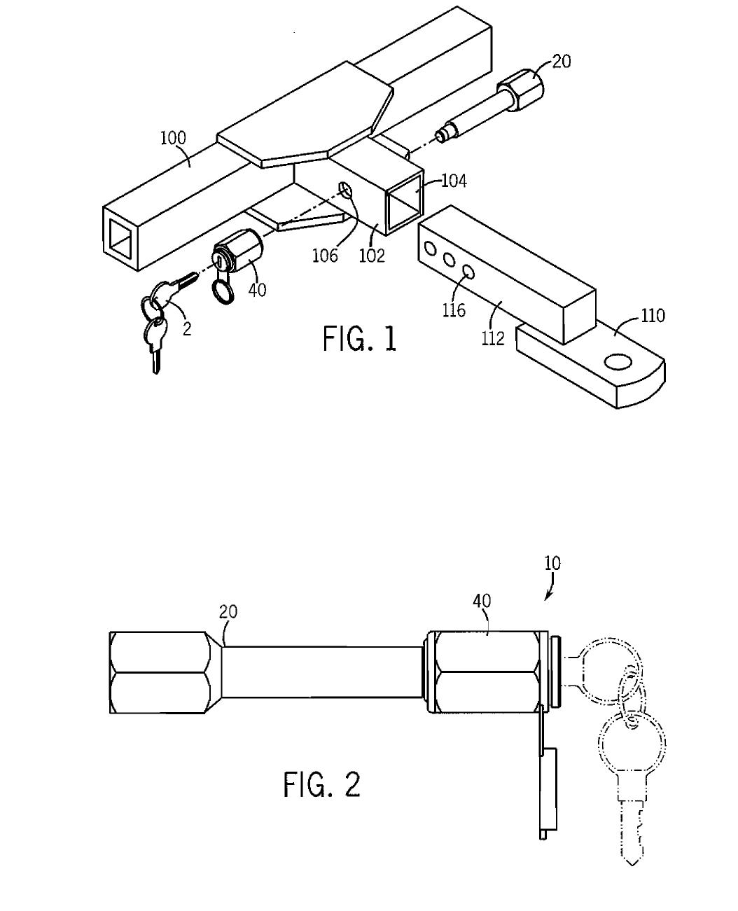

Referring now to the drawings in detail, wherein like numbered elements correspond to like elements throughout, FIG. 1 is a perspective view showing a first preferred embodiment of the receiver lock assembly, generally identified 10, that is constructed in accordance with the present invention. A trailer receiver 100 of the type that is well known in the art is illustrated in FIG. 1 to demonstrate how the receiver lock assembly 10 might be used in conjunction with it. The specific configuration shown is not, however, required and is in no way a limitation of the present invention.

As shown in FIG. 1, the trailer receiver 100 includes a forwardly-extending member 102 that is typically a hollow square-shaped tubular member having a longitudinally-extending aperture 104. Horizontally-aligned and opposing apertures 106 are defined within the sidewalls of the forwardly-extending member 102. A ball mount 110 includes a rearwardly-extending, and similarly square-shaped member 112 that is dimensioned to be slidably receivable within the aperture 104 of the hollow member 102. The members 102, 112 are intended to be engaged when a portion of a lock assembly 10 (see FIG. 2) is inserted through the corresponding apertures 106, 116, respectively, that are defined within those members.

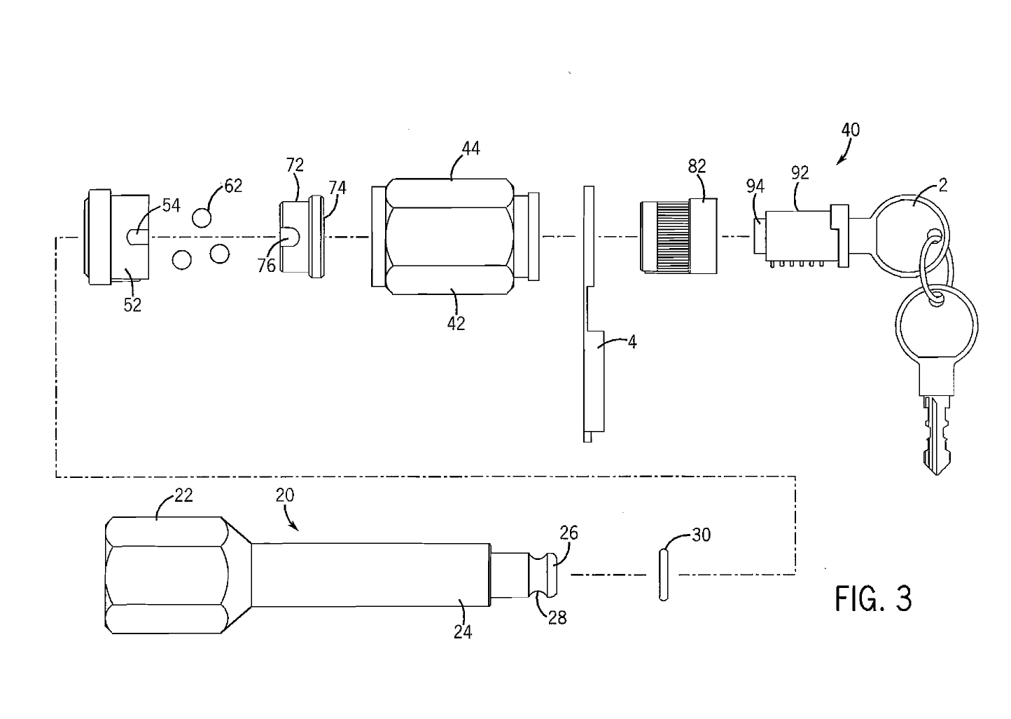

Referring again to FIG. 2, it illustrates one preferred embodiment of a receiver lock assembly 10 that is constructed in accordance with the present invention. As shown in FIG. 3, which is an enlarged and exploded view of the receiver lock assembly 10 that is shown in FIG. 2, it will be seen that the assembly 10 includes a lock head sub-assembly, generally identified 40, that comprises a lock head 42 which is essentially a barrel-like structure having an outer hexagonally-shaped cross-sectioned profile 44. Receivable within the lock head assembly 40 is one end 26 of a shaft head sub-assembly, generally identified 20. Together, these two sub-assemblies 20, 40 functionally cooperate to lockingly attach the ball mount 110 to the trailer receiver 100 as per FIG. 1.

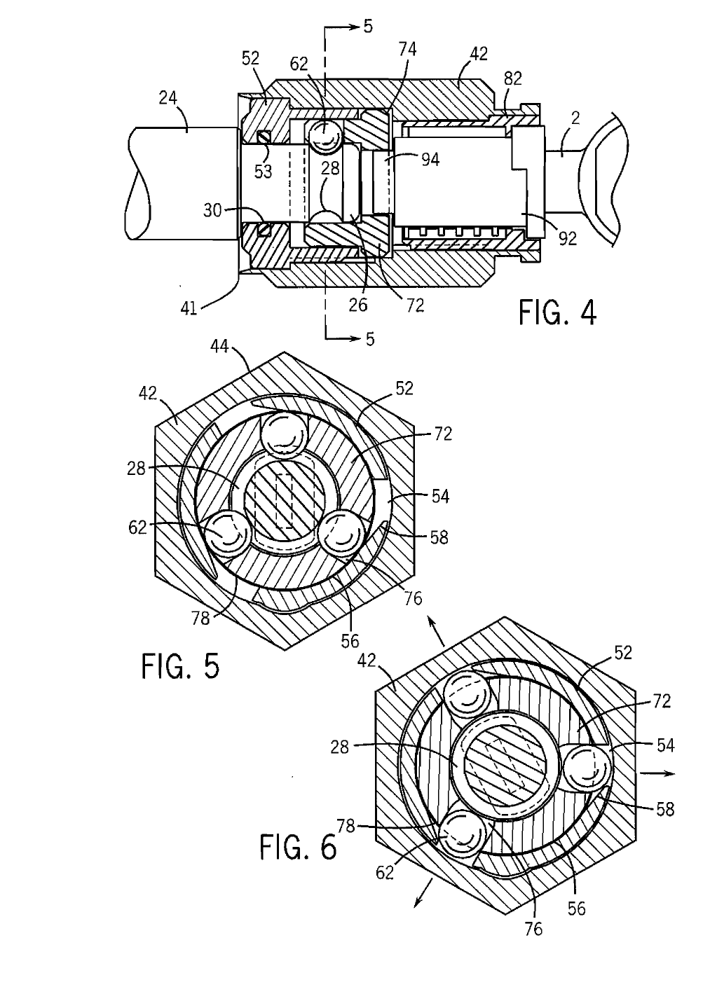

Moving from the top left of FIG. 3, it will be seen that, to one side or end of the barrel-like structure 42, is inserted a fixed cam 52, three steel balls 62 and a rotatable cam 72. As is shown in even greater detail in FIG. 4, the rotatable cam 72 includes a first end 74 that can be rotated by one end 94 of a lock 92. Referring again to FIG. 3, it will be seen that the lock 92 is receivable within a lock barrel 82. In practice, the lock 92 would be press-fit into the lock barrel 82 to remain secured within it. A key 2 is then used to actuate the lock 92. A dust cover 4 is provided to keep debris out of the lock 92 when the key 2 is not inserted into the lock 92.

Referring again to FIG. 4, it will be seen that an internal circumferential groove 53 is defined within the fixed cam 52, this circumferential groove 53 being functionally adapted to receive an O-ring 30 within it. The purpose of the O-ring 30 is to keep debris from entering that side of the lock head assembly 40 when the lock 92 and lock head 42 are lockingly engaged with the shaft head assembly 20 as shown in FIG. 2.

The shaft head assembly 20, also shown in exploded view in FIG. 3, comprises a shaft head 22 and a linearly-extending central shaft portion 24. The shaft head 22 has an outer hexagonally-shaped cross-sectioned profile that is similar to that of the lock head 42. The shaft head 22 can be fabricated with the shaft portion 24 as a unitary structure or alternatively as two structures secured to one another. Opposite the shaft head 22 is a shaft engagement portion 26 and a circumferential groove 28.

Referring again to FIG. 4, and also to FIGS. 5 and 6, it will be seen that two positions of the assembly 10 are represented. In one position, the rotatable cam 72, which has each of the balls 62 received within its apertures 76, has an outer surface 78 that is movable along the inner surface 56 of the fixed cam 52, this first position being illustrated by FIG. 6. In this first position, the balls 62 are also movable within an aperture 54 of the fixed cam 52. In view of this movement, this first position is considered the “unlocked” position of the assembly 10.

In FIG. 5, it will be seen that the rotatable cam 72 can be rotated slightly clockwise to a second position. This is considered the “locked” position of the assembly 10. In moving to this position, it will be appreciated that the balls 62 are urged away from the apertures 54 that are defined within the fixed cam 52 by means of the sloped portions 58 of the fixed cam 52. That is, when the rotatable cam 72 and the balls 62 contained within it are rotated, the balls 62 are forced into engagement with the circumferential groove 28 that is defined within the end of the shaft assembly 20. Thus, the rotating cam 72 and the fixed cam 52 allow the balls 62 to move into and out of engagement with the grooved shaft 24 on the shaft assembly 20.

In summary, FIGS. 4 and 5 specifically illustrate the condition where the balls 62 are engaged to “lock” the assembly 10 whereas FIG. 6 specifically illustrates the condition where the balls 62 are disengaged to “unlock” the assembly 10. It is also to be mentioned that, in an alternative embodiment (not shown), the lock head 42 and the fixed cam 52 could be fabricated as a one-piece, unitary structure.

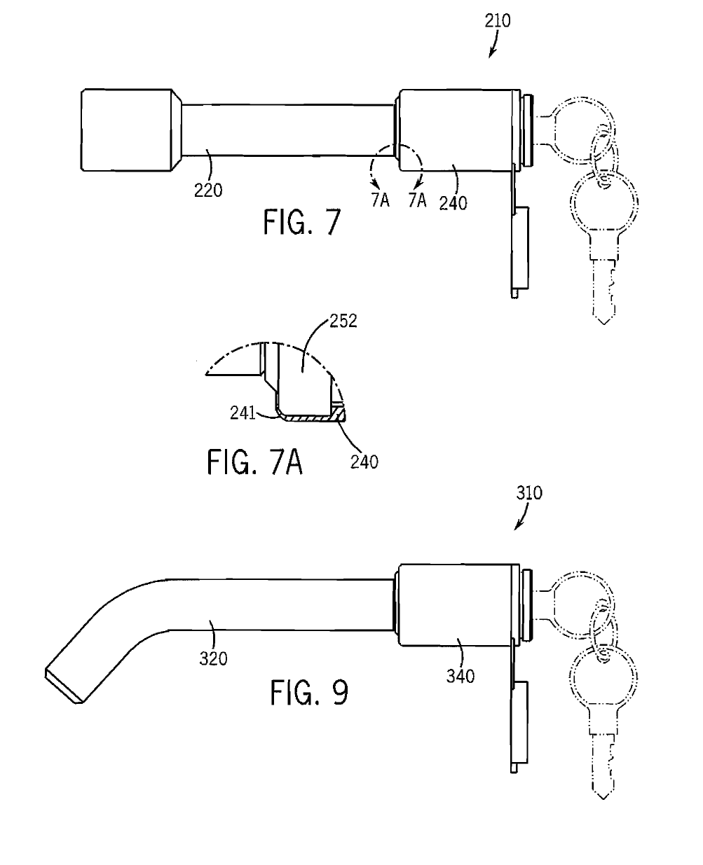

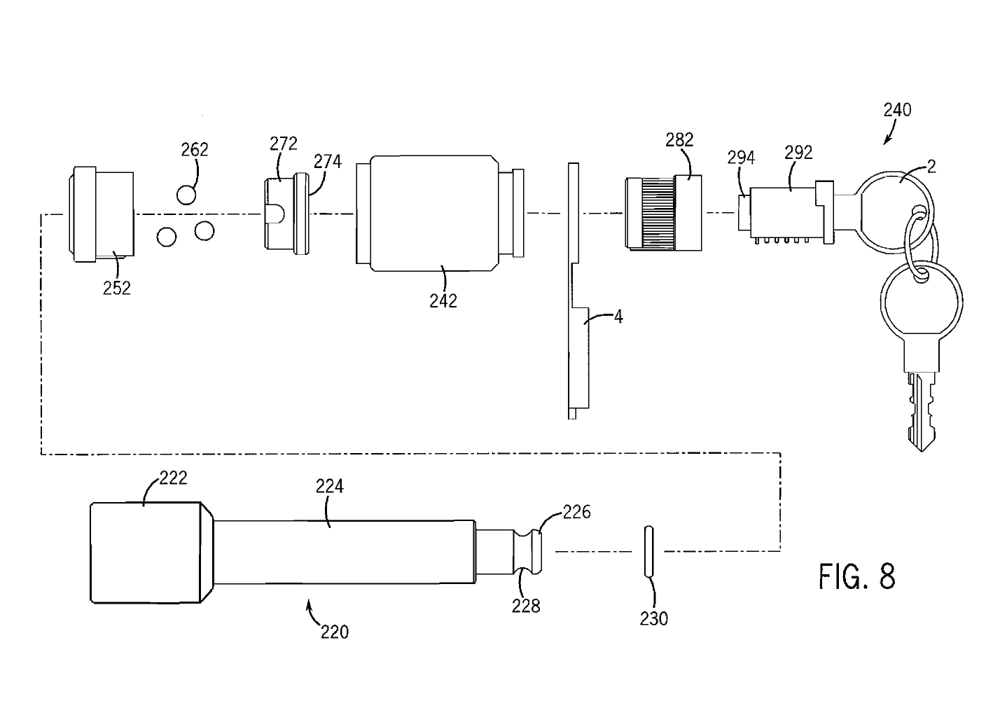

A second embodiment of the receiver lock assembly 210 is shown in FIG. 7 and in the exploded view of FIG. 8. The most significant feature of this particular embodiment is that the lock head 242 is a rounded barrel-like structure as compared to the hexagonal shape of the like structure of the first embodiment. Moving from the top left of FIG. 8, it will be seen that, to one side or end of the round barrel-like structure 242, is inserted a fixed cam 252, three steel balls 262 and a rotatable cam 272. As is shown in greater detail in FIG. 8, the cam 272 includes a first end 274 that can be rotated by one end 294 of a lock 292. A key 2 is used to actuate the lock 292. A dust cover 4 is similarly provided to keep debris out of the lock 292 when the key 2 is not inserted into the lock 292. FIG. 7A also illustrates how the peripheral circumferential edge 241 of the lock head 242 would be crimped over to “Capture” the fixed cam 252 within the lock head 242. The pre-crimped edge 41 of the like structure is illustrated in FIG. 4 relative to the first embodiment.

The shaft head assembly 220, also shown in exploded view in FIG. 8, comprises a shaft head 222 and a central shaft portion 224. The shaft head 222 is also a rounded barrel-like structure similar to that of the lock head 242. Opposite the shaft head 222 is an engagement means structure which comprises a shaft engagement portion 226 and a circumferential groove 228. The functionality and purpose of this groove 228 is identical to that of the groove 28 as described above relative to the first embodiment. An O-ring 230 is provided, the purpose of the O-ring 230 being the same as that of the O-ring 30 described above relative to the first embodiment.

The functionality of this alternative embodiment of a receiver lock assembly 210 is in all respects identical to that described above relative to the first embodiment of receiver lock assembly 10.

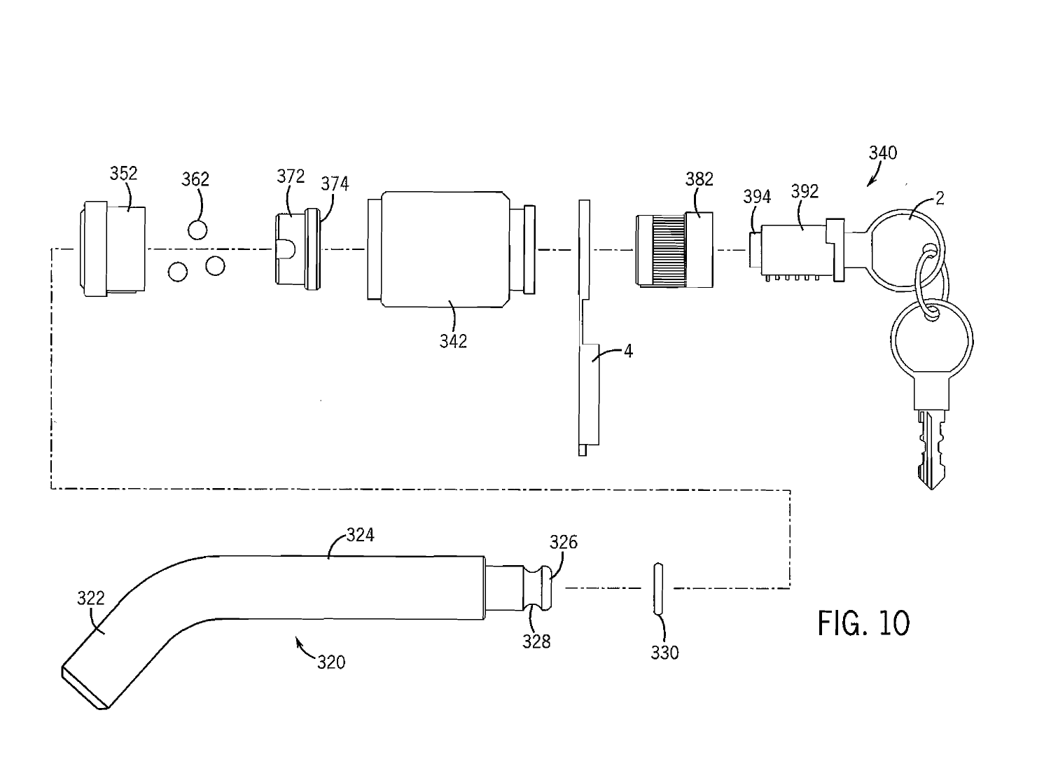

Yet a third embodiment of the receiver lock assembly 310 is shown in FIG. 9 and in the exploded view of FIG. 10. Moving from the top left of FIG. 10, it will be seen that, to one side or end of the barrel-like structure 342, is inserted a fixed cam 352, three steel balls 362 and a rotatable cam 372. As is shown in greater detail in FIG. 10, the rotatable cam 372 includes a first end 374 that can be rotated by one end 394 of a lock 392. A key 2 is used to actuate the lock 392. A dust cover 4 is again provided to keep debris out of the lock 392 when the key 2 is not inserted into it.

The shaft assembly 320, also shown in exploded view in FIG. 10, comprises a bent shaft portion 322 and a central shaft portion 324. The bent shaft portion 322 is intended to be a structure that would not be able to be drawn through the aligned apertures 106, 116 shown in FIG. 1, thus providing the same functionality of the shaft heads 22, 222 of the prior-described embodiments.

Opposite the bent shaft portion 322 is an engagement means structure which comprises a shaft engagement portion 326 and a circumferential groove 328. The functionality and purpose of this groove 328 is identical to that of the groove 28 as described above. An O-ring 330 is provided, the purpose of the O-ring 330 being the same as that of the O-ring 30 described above.

The functionality of this third embodiment of a receiver lock assembly 310 is in all respects identical to that described above relative to the first embodiment of receiver lock assembly 10.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

What is claimed is:

1. A receiver lock assembly (10) for use with a trailer receiver (100) and ball mount (110), said trailer receiver (100) and ball mount (110) having aligned apertures (106, 116) defined within them, said apertures (106, 116) being configured to receive a portion of the receiver lock assembly (10) within them, the receiver lock assembly (10) comprising:
a lock head sub-assembly (40), the lock head sub-assembly (40) comprising a lock head (42), and
a shaft sub-assembly (20), said shaft sub-assembly (20) comprising one end (26) that is lockingly receivable within the lock head (42).

2. The receiver lock assembly (10) of claim 1 wherein the lock head sub-assembly (40) further comprises
a fixed cam (52),
a plurality of balls (62), and
a rotatable cam (72).

3. The receiver lock assembly (10) of claim 2 wherein the fixed cam (52) comprises a plurality of ball-receiving apertures (54) and the rotatable cam (72) comprises a plurality of ball-receiving apertures (76).

4. The receiver lock assembly (10) of claim 3 wherein the fixed cam (52) further comprises a plurality of sloped portions (58) adjacent said ball-receiving apertures (54) for moving a ball (62) within the aperture (54) along the sloped portion (58) when the rotatable cam (72) is rotated relative to the fixed cam (52).

5. The receiver lock assembly (10) of claim 4 wherein the lock head (42) and the fixed cam (52) are made as a unitary structure.

6. The receiver lock assembly (10) of claim 4 wherein the lock head (42) is formed in a hexagonal cross-sectioned shape (44) and wherein the shaft sub-assembly (20) comprises a shaft head (22) that is formed in the same hexagonal cross-sectioned shape.

7. The receiver lock assembly (210) of claim 4 wherein the lock head (242) is formed in a round cross-sectioned shape and wherein the shaft sub-assembly (220) comprises a shaft head (222) that is formed in the same round cross-sectioned shape.

8. The receiver lock assembly (310) of claim 4 wherein the shaft sub-assembly (320) comprises a bent shaft portion (322).

9. The receiver lock assembly (10) of claim 1 wherein the lock head sub-assembly (40) further comprises
a fixed cam (52),
a plurality of balls (62), and
a rotatable cam (72),
and wherein the shaft sub-assembly (20) further comprises
a shaft (24), and
a circumferential groove (28) defined within the shaft (24).

10. The receiver lock assembly (10) of claim 9 wherein the fixed cam (52) comprises a plurality of ball-receiving apertures (54) and the rotatable cam (72) comprises a plurality of ball-receiving apertures (76).

11. The receiver lock assembly (10) of claim 10 wherein the fixed cam (52) further comprises a plurality of sloped portions (58) adjacent said ball-receiving apertures (54) for moving a ball (62) within the aperture (54) along the sloped portion (58) when the rotatable cam (72) is rotated relative to the fixed cam (52) and wherein each ball (62) engages the circumferential groove (28) defined within the shaft (24).

12. The receiver lock assembly (10) of claim 11 wherein the lock head (42) and the fixed cam (52) are made as a unitary structure.

13. The receiver lock assembly (10) of claim 11 wherein the lock head (42) is formed in a hexagonal cross-sectioned shape (44) and wherein the shaft sub-assembly (20) comprises a shaft head (22) that is formed in the same hexagonal cross-sectioned shape.

14. The receiver lock assembly (210) of claim 11 wherein the lock head (242) is formed in a round cross-sectioned shape and wherein the shaft sub-assembly (220) comprises a shaft head (222) that is formed in the same round cross-sectioned shape.

15. The receiver lock assembly (310) of claim 11 wherein the shaft sub-assembly (320) comprises a bent shaft portion (322).

16. A receiver lock assembly (10) for use with a trailer receiver (100) and ball mount (110), said trailer receiver (100) and ball mount (110) having aligned apertures (106, 116) defined within them, said apertures (106, 116) being configured to receive a portion of the receiver lock assembly (10) within them, the receiver lock assembly (10) comprising:
a lock head sub-assembly (40), the lock head sub-assembly (40) comprising a lock head (42),
a shaft sub-assembly (20), said shaft sub-assembly (20) comprising one end (26) that is lockingly receivable within the lock head (42), and
a locking means for securing the shaft end (26) within the lock head (42).

17. The receiver lock assembly (10) of claim 16 wherein the locking means comprises a lock head sub-assembly (40) having
a fixed cam (52),
a plurality of balls (62), and
a rotatable cam (72),
and a shaft sub-assembly (20) having
a shaft (24) and
a circumferential groove (28) defined within the shaft (24).

18. The receiver lock assembly (10) of claim 17 wherein the fixed cam (52) comprises a plurality of ball-receiving apertures (54) and the rotatable cam (72) comprises a plurality of ball-receiving apertures (76).

19. The receiver lock assembly (10) of claim 18 wherein the fixed cam (52) further comprises a plurality of sloped portions (58) adjacent said ball-receiving apertures (54) for moving a ball (62) within the aperture (54) along the sloped portion (58) when the rotatable cam (72) is rotated relative to the fixed cam (52) and wherein each ball (62) engages the circumferential groove (28) defined within the shaft (24).

20. The receiver lock assembly (10) of claim 19 wherein the lock head (42) and the fixed cam (52) are made as a unitary structure.

21. The receiver lock assembly (10) of claim 19 wherein the lock head (42) is formed in a hexagonal cross-sectioned shape (44) and wherein the shaft sub-assembly (20) comprises a shaft head (22) that is formed in the same hexagonal cross-sectioned shape.

22. The receiver lock assembly (210) of claim 19 wherein the lock head (242) is formed in a round cross-sectioned shape and wherein the shaft sub-assembly (220) comprises a shaft head (222) that is formed in the same round cross-sectioned shape.

23. The receiver lock assembly (310) of claim 19 wherein the shaft sub-assembly (320) comprises a bent shaft portion (322).
